(19) United States
(12) Patent Application Publication
(10) Pub. No.: US 2026/0344635 A1
(43) Pub. Date: Nov. 5, 2026

(54) FISHING LINE BINDING AUXILIARY TOOL AND SLIDE FASTENER WITH FISHING LINE BINDING AUXILIARY FUNCTION

(71) Applicant: YKK CORPORATION, Tokyo (JP)

(72) Inventors: Masayoshi KOJIMA, Toyama (JP); Nozomi TSUGE, Toyama (JP); Yoshito SAKAMOTO, Toyama (JP)

(21) Appl. No.: 19/665,235

(22) Filed: May 1, 2026

(30) Foreign Application Priority Data
May 2, 2025 (JP) 2025-076682

(51) Int. Cl. A01K 91/047

(52) U.S. Cl. CPC A01K 91/047

(57) ABSTRACT

A fishing line binding auxiliary tool includes: a body portion having a thickness. The body portion has a front surface constituting one surface, a back surface constituting a surface opposite to the front surface, a side surface that is an outer peripheral surface located between the front surface and the back surface, a slit formed in the side surface along a thickness direction of the body portion and penetrating the front surface and the back surface, and an attachment portion configured to couple the body portion to another member. The slit engages a fishing line when the fishing line passes through a bottom portion of the slit, the front surface, and the back surface and is wound around the body portion.

### CROSS-REFERENCE TO RELATED APPLICATIONS

This application is based on and claims priority under 35 USC §119 from Japanese Patent Application No. 2025-076682 filed on May 2, 2025, the contents of which are incorporated herein by reference.

### TECHNICAL FIELD

The present invention relates to a fishing line binding auxiliary tool that, when tying a knot on a fishing line to couple with a leader line, stretches and holds the fishing line and assists the coupling operation, and a slide fastener with fishing line binding auxiliary function.

### BACKGROUND

In the related art, when tying a knot at a tip end of a fishing line, which is made of polyethylene or the like and is pulled out from a tip end of a fishing rod, to couple with a leader line, there is a dedicated member that stretches and clamps a tip end portion of the fishing line and assists the coupling operation. For example, a fishing line processing stick disclosed in Patent Literature 1 includes a cylindrical stick-shaped body portion and a fishing line fixing portion that is disposed at another end of the body portion and clamps and fixes a fishing line. The fishing line fixing portion is provided with first and second clamping members, and the fishing line is clamped between the first and second clamping members. An interval between the first and second clamping members is adjustable, and the first and second clamping members clamp the fishing line when pressed against each other, and release the fishing line when separated from each other. In a using method of the fishing line processing stick, a carabiner is attached to the body portion and engaged to a loop of a user's garment. Then, the fishing line is pulled out from a tip end of a fishing rod, and a tip end side of the fishing line is held by the fishing line processing stick. The fishing line can be stretched by being wound around a reel of the fishing rod, and a knot is tied on the stretched and held fishing line to couple with a leader line.

Further, a clamp for tying fishing line knot disclosed in Patent Literature 2 includes a body having a first disk plate and a second disk plate, and a space is defined between the first disk plate and the second disk plate. The first disk plate includes a cylindrical portion protruding into the space, and the cylindrical portion is provided with a female spiral portion. The second disk plate is provided with a male spiral portion that is inserted into the cylindrical portion and screwed into the female spiral portion. A pair of outer rings that hold the fishing line are provided in the space, and the fishing line is held between the pair of outer rings. When the first disk plate and the second disk plate are rotated, a pressing force of the pair of outer rings can be changed by screwing of the female spiral portion and the male spiral portion, and the pair of outer rings clamp the fishing line when pressed against each other, and release the fishing line when separated from each other. In a using method of the clamp for tying fishing line knot, a binding band is attached to a body and is worn on each of two feet of a user, the fishing line is stretched between two bodies, a knot is tied on the stretched and held fishing line to couple with a leader line.

Patent Literature 1:
JP5300109B Patent Literature 2: JP2022-164580A

The fishing line binding auxiliary tools in the related art have complicated structures and high manufacturing costs. Further, the tools are large in sizes, bulky when carried and used, and difficult to use.

The present invention is made in view of the above problems in the background art, and an object of the present invention is to provide a fishing line binding auxiliary tool that has a simple structure and a compact size, can reliably stretch and hold a fishing line by a simple operation, and can assist an operation of tying a knot on the fishing line to couple with a leader line, and a slide fastener with fishing line binding auxiliary function.

### SUMMARY

A fishing line binding auxiliary tool includes: a body portion having a thickness. The body portion has a front surface constituting one surface, a back surface constituting a surface opposite to the front surface, a side surface that is an outer peripheral surface located between the front surface and the back surface, a slit formed in the side surface along a thickness direction of the body portion and penetrating the front surface and the back surface, and an attachment portion configured to couple the body portion to another member. The slit engages a fishing line when the fishing line passes through a bottom portion of the slit, the front surface, and the back surface and is wound around the body portion.

The attachment portion may be provided in a vicinity of the slit. The attachment portion may be coupled to the other member to be located at a position close to a user, the fishing line may be configured to be engaged to the body portion on a side of a tip end portion thereof, and when an opposite end portion of the fishing line is pulled and separated in a direction away from the user, a longitudinal direction of the fishing line may coincide with a direction in which the bottom portion of the slit is connected to the user substantially on a straight line. The body portion may have a plate body shape, the front surface may constitute one surface of the plate body, and the back surface may constitute a surface of the plate body which is opposite to the front surface.

The slit may be recessed in a direction intersecting the thickness direction of the body portion toward a center of the body portion, and the slit may have a V shape. A notch may be formed toward the center of the body portion in at least a part of the front surface or the back surface in the bottom portion of the slit. A pair of the slits may be provided, and the slits may be located on opposite sides of a center of the body portion.

The attachment portion may be provided with a coupling member configured to couple the body portion to the other member. The attachment portion may be couplable to a slider of a slide fastener located at a position close to a user.

There is provided a slide fastener with fishing line binding auxiliary function. The slide fastener includes a fishing line binding auxiliary tool on a slider thereof. The fishing line binding auxiliary tool includes a body portion having a thickness. The body portion has a front surface constituting one surface, a back surface constituting a surface opposite to the front surface, a side surface that is an outer peripheral surface located between the front surface and the back surface, a slit formed in the side surface along a thickness direction of the body portion and penetrating the front surface and the back surface, and an attachment portion configured to couple the body portion to the slider. The slit engages a fishing line when the fishing line passes through a bottom portion of the slit, the front surface, and the back surface and is wound around the body portion.

The slide fastener may be configured to be attached to a body front surface of a user along an upper-lower direction, and the fishing line binding auxiliary tool may be movable in the upper-lower direction on the body front surface of the user by the slider moving along a longitudinal direction of the slide fastener. The slide fastener may be configured to be attached to a garment worn by the user. The fishing line binding auxiliary tool may be attached to a pull of the slider.

### BRIEF DESCRIPTION OF DRAWINGS

FIGS. 1A - 1C are a front view, a right side view, and a bottom view of a fishing line binding auxiliary tool according to a first embodiment of the present invention.

FIG. 2 is a front view showing a using method of the fishing line binding auxiliary tool according to the first embodiment of the present invention.

FIG. 3 is a perspective view showing the using method of the fishing line binding auxiliary tool according to the first embodiment of the present invention.

FIG. 4 is a perspective view showing the using method of the fishing line binding auxiliary tool according to the first embodiment of the present invention.

FIG. 5 is a front view showing a fishing line binding auxiliary tool according to a second embodiment of the present invention.

FIG. 6 is a front view showing a fishing line binding auxiliary tool according to a third embodiment of the present invention.

FIG. 7 is a front view showing a fishing line binding auxiliary tool according to a fourth embodiment of the present invention.

### DESCRIPTION OF EMBODIMENTS

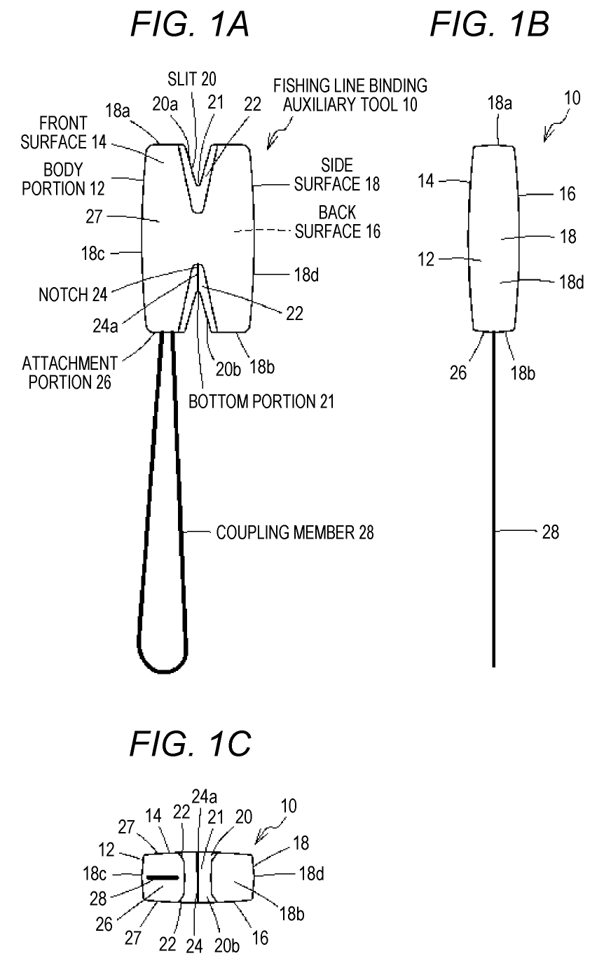

Hereinafter, embodiments of the present invention will be described with reference to the drawings. FIGS. 1A - 4 show a first embodiment of the present invention, and a fishing line binding auxiliary tool 10 according to the present embodiment includes a body portion 12 made of a resin material or the like, and the material of the body portion 12 is silicone resin, rubber, polyurethane, nylon, polyethylene, or the like that has appropriate pliancy and elasticity, which is preferably softer than a fishing line 38 to be described later, and may also be formed of metal, ceramic, wood, or the like. The body portion 12 has a plate body shape having a thickness, and a shape of a plate surface is a rectangle slightly longer in one direction. The body portion 12 has a front surface 14 constituting one surface of the plate surface, a back surface 16 constituting a surface opposite to the front surface 14, and a side surface 18 that is an outer peripheral surface located between the front surface 14 and the back surface 16.

Side surfaces 18a and 18b of the side surface 18 located at end portions in a longitudinal direction of the body portion 12 are each provided with a slit 20 that is formed along a thickness direction of the body portion 12 and penetrates the front surface 14 and the back surface 16. The slit 20 engages the fishing line 38 to the body portion 12 when the fishing line 38 passes through a bottom portion 21 of the slit 20, the front surface 14, and the back surface 16 and is wound around the body portion 12. The slit 20 intersecting the body portion 12 in the thickness direction has a V shape in which an opening narrows toward the bottom portion 21 in the body portion 12. A corner at a boundary part between an inner wall portion of the slit 20 and the front surface 14 or the back surface 16 is chamfered, at which an inclined portion 22 is provided.

A pair of slits 20 are provided, the slit 20 provided in the side surface 18a is a slit 20a, and the slit 20 provided in the side surface 18b is a slit 20b. The slit 20a and the slit 20b have the same shape, and are symmetrically located on opposite sides of a center of the body portion 12. The body portion 12 has an H shape due to the slits 20a and 20b. In the slit 20b, a notch 24 is further formed toward an inside of the body portion 12 at a most recessed position of the V shape. The notch 24 also penetrates the front surface 14 and the back surface 16, and a part thereof which has a length of about half of the notch 24 on a front surface 14 side is provided with a large-width portion 24a having a large width in a direction parallel to the side surface 18b. The notch 24 may be formed later with a cutter or the like. The notch 24 is a groove that has such a width that the fishing line 38 would not be greatly displaced in a left-right direction, and is inclined at an angle different from that of the inclined portion 22.

Side surfaces 18c and 18d of the body portion 12 that intersect the side surfaces 18a and 18b are formed as curved surfaces whose centers slightly bulge outward. In FIG. 1A, when the side surface 18a is on an upper side of a paper, the side surface 18c is on a left side, and the side surface 18d is on a right side. A position of the side surface 18b which is close to a corner portion with the side surface 18c serves as an attachment portion 26 that couples the body portion 12 to another member. The attachment portion 26 may be located in a vicinity of or be adjacent to the slit 20b. A part of the front surface 14 and a part of the back surface 16 on a side surface 18c side serve as a gripping portion 27 for a user 34 to grip the body portion 12 by grabbing the front surface 14 and the back surface 16 when winding the fishing line 38 to be described later around the body portion 12. That is, a part on the same side with the attachment portion 26 serves as the gripping portion 27.

The attachment portion 26 is provided with a coupling member 28 that couples the body portion 12 to another member. The coupling member 28 is an annular cord body, and is folded in half lengthwise, and both end portions thereof are fixed to the attachment portion 26 by insert molding. The coupling member 28 has a length, for example, about four times a length of the body portion 12 in the longitudinal direction, and is about twice the length in a state of being folded in half.

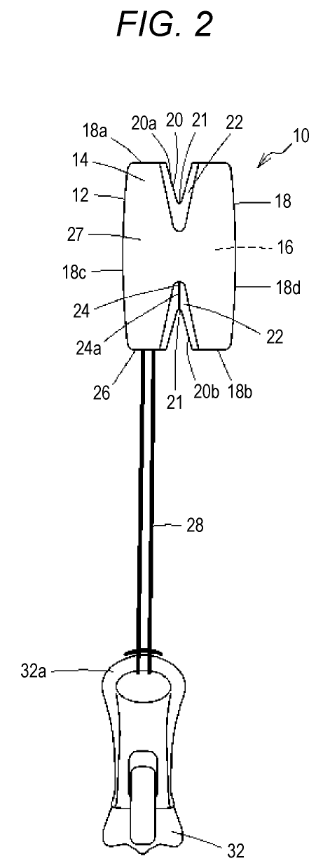

Next, a using method of the fishing line binding auxiliary tool 10 according to the present embodiment will be described. During fishing, the fishing line binding auxiliary tool 10 is attached to another member by the coupling member 28. Here, as shown in FIGS. 2 - 4, the other member is a pull 32a of a slider 32 of a slide fastener 30, and the slide fastener 30 is provided along an upper-lower direction at a front center of a garment worn by the user 34, here, a jacket 36, and opens and closes the front center when the jacket 36 is put on and taken off.

The user 34 winds a tip end portion 38a of the fishing line 38, which is pulled out from a tip end of a fishing rod, around the body portion 12 of the fishing line binding auxiliary tool 10 a plurality of times with appropriate tension, passing through the bottom portions 21 of the slits 20a and 20b, the front surface 14, and the back surface 16. The fishing line 38 is engaged by friction of the body portion 12 made of a soft material. When being wound, the fishing line 38 is easily wound around the slits 20a and 20b because the inclined portion 22 is provided at a boundary between the slits 20a and 20b and the front surface 14 and the back surface 16. The notch 24 is provided in the bottom portion 21 of the slit 20b, and the fishing line 38 is inserted into and reliably held in the notch 24. Since the notch 24 has the large-width portion 24a, the fishing line 38 is easily inserted into the notch 24. When the fishing line 38 is wound around the body portion 12, it is easy to perform an operation by grabbing the gripping portion 27 on the front surface 14 and the back surface 16 with one hand and winding the fishing line 38 with another hand. The notch 24 allows the fishing line 38 to be fixed to a certain extent, and allows the fishing line 38 to be fixed at a start of winding of the fishing line 38. Therefore, the notch 24 is preferably located on an attachment portion 26 side.

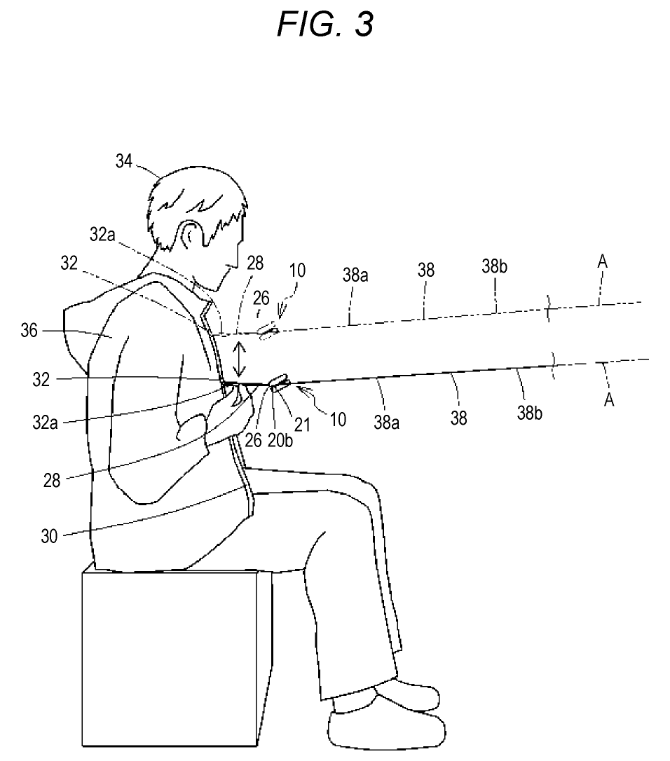

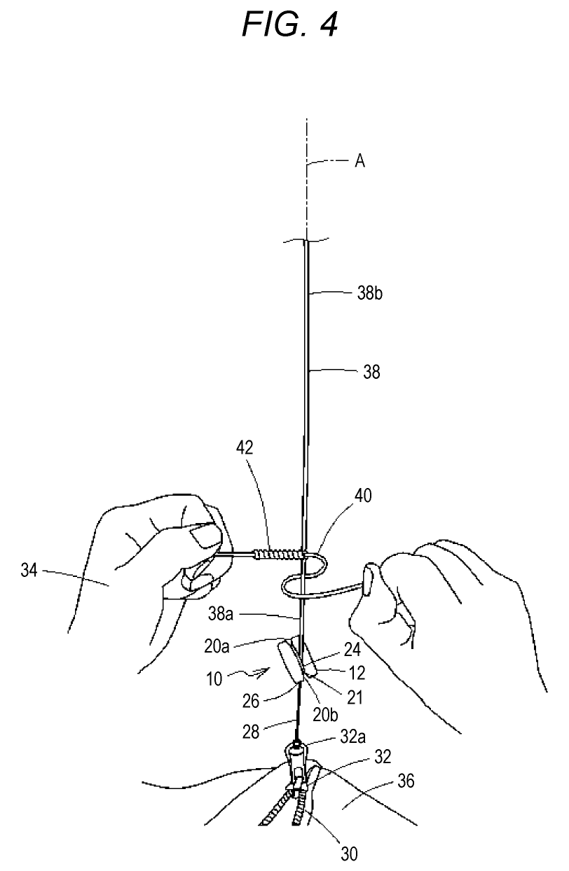

When an opposite end portion 38b of the fishing line 38 is pulled and separated in a direction away from the user 34, a longitudinal direction of the fishing line 38 extends in a direction away from the user 34, and the longitudinal direction of the fishing line 38 coincides with a direction in which the bottom portion 21 of the slit 20b in a vicinity of the attachment portion 26 is connected to the user 34 substantially on a straight line A, as shown in FIGS. 3 and 4. The opposite end portion 38b of the fishing line 38 is set on a reel of the fishing rod, and is applied with tension to be pulled and separated in a direction away from the user 34 by winding the reel.

Next, as shown in FIG. 4, a leader line 40 is coupled to a tip end portion 38a side of the stretched fishing line 38 by tying a knot 42. Since the slide fastener 30 is attached to a body front surface of the user 34 along the upper-lower direction, the fishing line binding auxiliary tool 10 can be moved to a freely selected position in the upper-lower direction on the body front surface of the user 34 by the slider 32 moving along a longitudinal direction of the slide fastener 30, and it is easy to move the fishing line binding auxiliary tool 10 to a position on which eyes of the user 34 are focused. The leader line 40 is coupled to the fishing line 38 since the material of the fishing line 38 is polyethylene and has a disadvantage of easy breakage or the like, and the leader line 40 with high durability is coupled.

The fishing line binding auxiliary tool 10 is preferably attached to the slide fastener 30 provided along the upper-lower direction at the front center of the jacket 36 worn by the user 34, and may also be attached to another member such as a belt or a waist bag. The body portion 12 has the same size as the slider 32, and may have any size that is available, and may also have a size different from that of the slider 32.

According to the fishing line binding auxiliary tool 10 in the present embodiment, the fishing line binding auxiliary tool 10 has a simple structure and a compact size, and is easy to use without being bulky when carried and used. The fishing line binding auxiliary tool 10 can assist an operation of reliably stretching and holding the fishing line 38 with a simple operation and tying the knot 42 on the fishing line 38 to couple with the leader line 40. The knot 42 is easy to tie since the longitudinal direction of the fishing line 38 coincides with the direction in which the bottom portion 21 of the slit 20b is connected to the user 34 substantially on the straight line A. When the knot 42 is tied by holding the leader line 40 with left and right hands, the leader line 40 is substantially perpendicular to the fishing line 38 and would not interfere with the operation of tying the knot 42. Further, as tension is applied to the fishing line 38, the slit 20 and the notch 24 are strongly bitten, and an attachment strength increases.

Further, by attaching the fishing line binding auxiliary tool 10 to the slide fastener 30, there is no risk of falling or loss. The fishing line binding auxiliary tool 10 can be used immediately when necessary. By moving the slider 32 along the longitudinal direction of the slide fastener 30, the fishing line binding auxiliary tool 10 can be moved in the upper-lower direction on the body front surface of the user 34, and the knot 42 can be tied, which is a fine operation, at a position where the eyes of the user 34 are focused. When opening and closing the slide fastener 30, the slide fastener 30 can be easily opened and closed by grabbing the fishing line binding auxiliary tool 10 with a hand and moving the slider 32, and the fishing line binding auxiliary tool 10 is easier to grab and pull than in a case of opening and closing the slide fastener 30 by holding the pull 32a of the slider 32. The fishing line binding auxiliary tool 10 can be attached to a member other than the slide fastener 30.

In the fishing line binding auxiliary tool 10, the fishing line 38 is held by friction of the soft body portion 12 by simply winding the fishing line 38 around the slit 20 a plurality of times, and the fishing line binding auxiliary tool 10 can be easily manufactured with no screw or the like in a simple shape and at low cost. The fishing line 38 is easy to attach and detach, and a feeling of use is good. The attachment of the fishing line binding auxiliary tool 10 to the slider 32 of the slide fastener 30 can also be performed by a simple operation of connecting the coupling member 28. The front surface 14 and the back surface 16 are flat and available for design, and can be provided with a logo or the like.

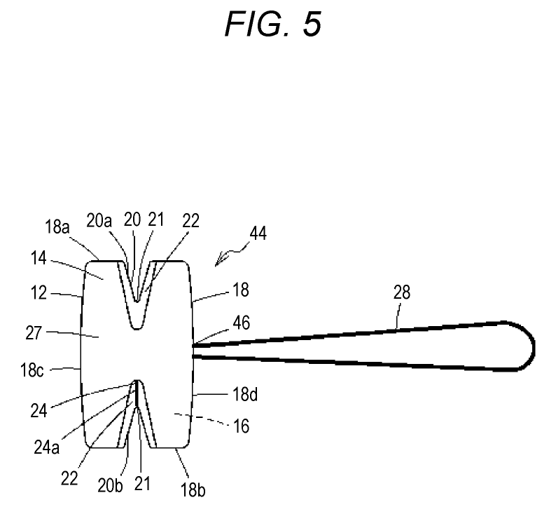

Hereinafter, a second embodiment of the present invention will be described with reference to FIG. 5. Here, the same members as those in the above-described embodiment are denoted by the same reference numerals, and descriptions thereof are omitted. In a fishing line binding auxiliary tool 44 according to the present embodiment, when the side surface 18a faces an upper side in FIG. 5, a center of the side surface 18d located on a right side serves as an attachment portion 46 that couples the body portion 12 to another member. The attachment portion 46 is provided with the coupling member 28 that couples the body portion 12 to another member.

The fishing line binding auxiliary tool 44 according to the present embodiment has the same using method and the same effects as that in the first embodiment.

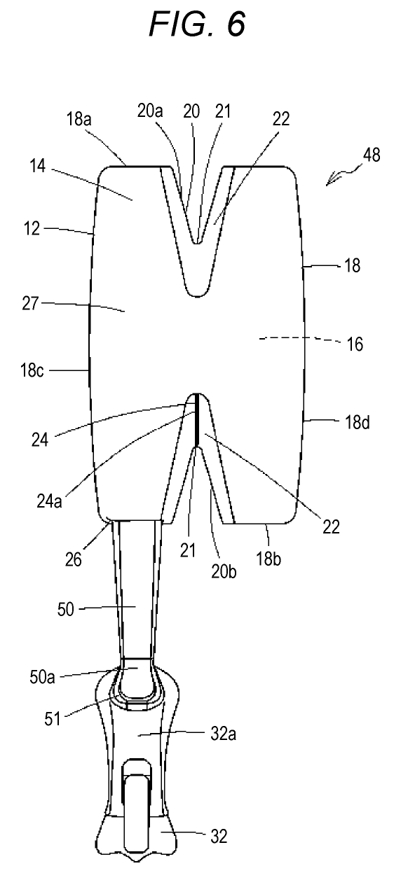

Hereinafter, a third embodiment of the present invention will be described with reference to FIG. 6. Here, the same members as those in the above-described embodiments are denoted by the same reference numerals, and descriptions thereof are omitted. In a fishing line binding auxiliary tool 48 according to the present embodiment, in FIG. 6, when the side surface 18a faces an upper side, a position of the side surface 18b located on a lower side which is close to a corner portion with the side surface 18c, serves as the attachment portion 26 that couples the body portion 12 to the slider 32. The attachment portion 26 is provided with a coupling member 50 that couples the body portion 12 to the slider 32. The coupling member 50 is a belt-shaped body having a surface substantially parallel to the front surface 14 of the body portion 12, a longitudinal direction of the coupling member 50 extends in a direction substantially perpendicular to the side surface 18b of the body portion 12, and a length of the coupling member 50 in the longitudinal direction is, for example, about half the length of the body portion 12 in the longitudinal direction. One end portion of the coupling member 50 in the longitudinal direction is insert-molded and fixed to the body portion 12, and an opposite end portion 50a protrudes from the body portion 12 by a predetermined length. The end portion 50a is provided with an engagement portion 51, and is attached to the pull 32a of the slider 32 by the engagement portion 51. The coupling member 50 may be formed of fibers, or may be a plate body made of resin or metal.

The fishing line binding auxiliary tool 48 according to the present embodiment has the same effects as those of the above embodiments. Since the fishing line binding auxiliary tool 48 and the slider 32 are coupled by the coupling member 50 that is a belt-shaped body, an orientation of the fishing line binding auxiliary tool 48 is stabilized, and the fishing line 38 is easy to engage.

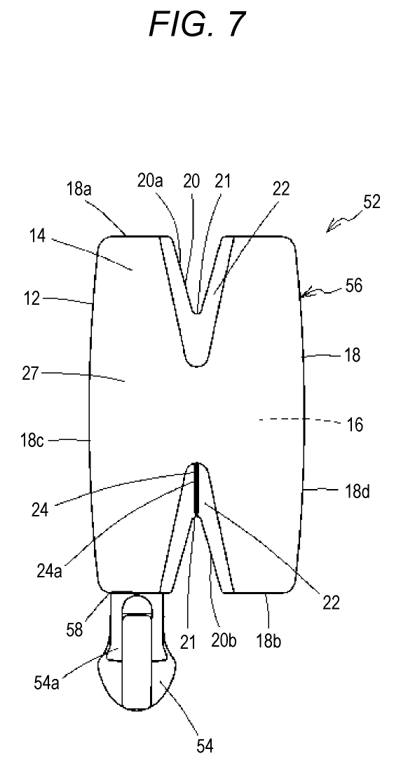

Hereinafter, a fourth embodiment of the present invention will be described with reference to FIG. 7. Here, the same members as those in the above-described embodiments are denoted by the same reference numerals, and descriptions thereof are omitted. The present embodiment describes a slide fastener with fishing line binding auxiliary function 52, and a fishing line binding auxiliary tool 56 is provided integrally with a pull 54a of a slider 54 that opens and closes the slide fastener with fishing line binding auxiliary function 52.

In the fishing line binding auxiliary tool 56, when the side surface 18a faces an upper side in FIG. 7, a position of the side surface 18b located on a lower side which is close to a corner portion with the side surface 18c serves as an attachment portion 58 that couples the body portion 12 to the slider 54. The attachment portion 58 may be located in a vicinity of or be adjacent to the slit 20b. The pull 54a of the slider 54 is fixed to the attachment portion 58. A longitudinal direction of the pull 54a is substantially perpendicular to the side surface 18b of the body portion 12, and substantially a half of a tip end side in the longitudinal direction of the pull 54a is insert-molded in the body portion 12.

The slide fastener with fishing line binding auxiliary function 52 according to the present embodiment is attached to the jacket 36, a waist bag, or the like worn by the user 34 by sewing or the like. Similar to the above embodiments, during fishing, the tip end portion 38a of the fishing line 38 set on a fishing rod is wound around and engaged to the fishing line binding auxiliary tool 56 a plurality of times with appropriate tension. When the opposite end portion 38b of the fishing line 38 is pulled and separated in a direction away from the user 34, the longitudinal direction of the fishing line 38 extends in a direction away from the user 34, and the leader line 40 is coupled to the tip end portion 38a of the stretched fishing line 38 by tying the knot 42.

The slide fastener with fishing line binding auxiliary function 52 according to the present embodiment has the same effects as those of the above embodiments. Further, since the fishing line binding auxiliary tool 56 is directly fixed to the slider 54, the slide fastener with fishing line binding auxiliary function 52 has a high attachment strength and would not be detached. No coupling member is necessary and a structure is simple. When the slide fastener with fishing line binding auxiliary function 52 is attached to a product such as a garment or a waist bag by sewing or the like, a product with a fishing line binding auxiliary function is obtained. Since the product has a fishing line binding auxiliary function, it is not necessary to carry the fishing line binding auxiliary tool 56, and the fishing line binding auxiliary tool 56 would not be dropped or lost.

The fishing line binding auxiliary tool and the slide fastener with fishing line binding auxiliary function of the present invention are not limited to the above embodiments. A shape of a body portion is not limited to those in the above embodiments, and may be a disk or a triangular plate, or a sphere or an ellipsoid other than a plate body. A pair of slits may not be provided on opposite sides of a center of the body portion, and may be provided at positions where a user can grip the body portion and wind a fishing line without hindrance. Shapes of the slits may be a shape other than a V shape as long as the fishing line can be engaged, and a notch of the slit may not be provided. The slit located on a side opposite to the user during use may be omitted. A coupling member that couples the body portion and another member may be a member other than a cord body or a belt-shaped body, and may be a chain, a carabiner, or the like. A position of an attachment portion can be freely changed, and an accommodation space for accommodating the coupling member may be provided in the body portion.

The fishing line binding auxiliary tool of the present invention has a simple structure and a compact size, can reliably stretch and hold a fishing line by a simple operation, and can assist an operation of tying a knot on the fishing line to couple with a leader line. When the fishing line binding auxiliary tool is attached to a slide fastener of a garment worn by a user, the slide fastener can be easily opened and closed without dropping or losing the fishing line binding auxiliary tool by grabbing the fishing line binding auxiliary tool with a hand and moving a slider.

What is claimed is:

1. A fishing line binding auxiliary tool comprising:
a body portion having a thickness, wherein
the body portion has a front surface constituting one surface, a back surface constituting a surface opposite to the front surface, a side surface that is an outer peripheral surface located between the front surface and the back surface, a slit formed in the side surface along a thickness direction of the body portion and penetrating the front surface and the back surface, and an attachment portion configured to couple the body portion to another member, and
the slit engages a fishing line when the fishing line passes through a bottom portion of the slit, the front surface, and the back surface and is wound around the body portion.

2. The fishing line binding auxiliary tool according to claim 1, wherein
the attachment portion is provided in a vicinity of the slit, and
the attachment portion is coupled to the other member to be located at a position close to a user, the fishing line is configured to be engaged to the body portion on a side of a tip end portion thereof, and when an opposite end portion of the fishing line is pulled and separated in a direction away from the user, a longitudinal direction of the fishing line coincides with a direction in which the bottom portion of the slit is connected to the user substantially on a straight line.

3. The fishing line binding auxiliary tool according to claim 1, wherein
the body portion has a plate body shape, the front surface constitutes one surface of the plate body, and the back surface constitutes a surface of the plate body which is opposite to the front surface.

4. The fishing line binding auxiliary tool according to claim 1, wherein
the slit is recessed in a direction intersecting the thickness direction of the body portion toward a center of the body portion, and the slit has a V shape.

5. The fishing line binding auxiliary tool according to claim 4, wherein
a notch is formed toward the center of the body portion in at least a part of the front surface or the back surface in the bottom portion of the slit.

6. The fishing line binding auxiliary tool according to claim 1, wherein
a pair of the slits are provided, and the slits are located on opposite sides of a center of the body portion.

7. The fishing line binding auxiliary tool according to claim 1, wherein
the attachment portion is provided with a coupling member configured to couple the body portion to the other member.

8. The fishing line binding auxiliary tool according to claim 1, wherein
the attachment portion is couplable to a slider of a slide fastener located at a position close to a user.

9. A slide fastener with fishing line binding auxiliary function, wherein
the slide fastener includes a fishing line binding auxiliary tool on a slider thereof,
the fishing line binding auxiliary tool includes a body portion having a thickness,
the body portion has a front surface constituting one surface, a back surface constituting a surface opposite to the front surface, a side surface that is an outer peripheral surface located between the front surface and the back surface, a slit formed in the side surface along a thickness direction of the body portion and penetrating the front surface and the back surface, and an attachment portion configured to couple the body portion to the slider, and
the slit engages a fishing line when the fishing line passes through a bottom portion of the slit, the front surface, and the back surface and is wound around the body portion.

10. The slide fastener with fishing line binding auxiliary function according to claim 9, wherein
the slide fastener is configured to be attached to a body front surface of a user along an upper-lower direction, and the fishing line binding auxiliary tool is movable in the upper-lower direction on the body front surface of the user by the slider moving along a longitudinal direction of the slide fastener.

11. The slide fastener with fishing line binding auxiliary function according to claim 10, wherein
the slide fastener is configured to be attached to a garment worn by the user.

12. The slide fastener with fishing line binding auxiliary function according to claim 9, wherein
the fishing line binding auxiliary tool is attached to a pull of the slider.
